(19) United States
(12) Patent Application Publication
(10) Pub. No.: US 2020/0222897 A1
(43) Pub. Date: Jul. 16, 2020

(54) IN-SITU ANALYZER FOR NUTRITIVE SALT AND NUTRITIVE SALT CONTENT ANALYSIS METHOD

(71) Applicant: SHENZHEN LIGHTSUN TECHNOLOGY COMPANY LIMITED, Shenzhen (CN)

(72) Inventors: Zongwei CHEN, Shenzhen (CN); Fangfang MA, Shenzhen (CN); Jiayu XIE, Shenzhen (CN); Jianhong YANG, Shenzhen (CN); Yi'an XU, Shenzhen (CN); Jun DONG, Shenzhen (GD); Qingliu HUAN, Shenzhen (GD)

(73) Assignee: SHENZHEN LIGHTSUN TECHNOLOGY COMPANY LIMITED, Shenzhen (CN)

(21) Appl. No.: 16/835,332

(22) Filed: Mar. 31, 2020

Related U.S. Application Data
(63) Continuation of application No. PCT/CN2018/099845, filed on Aug. 10, 2018.

(30) Foreign Application Priority Data
Dec. 4, 2017 (CN) 201711260674.5

(51) Int. Cl. B01L 3/00; G01N 21/78

(52) U.S. Cl. CPC B01L 3/502; G01N 2021/754; G01N 21/78

(57) ABSTRACT

An in-situ analyzer for a nutritive salt includes an injector, a calorimetric detector (11), a mixing ring (12), a sample pipeline, a pure water bin, a standard solution bin and various reagent bins of the analyzer which are correspondingly connected to ports of a multi-way valve (5). A microprocessor is connected to a first motor driver and a first motor in turn, and then connected to an injection pump (6) of the injector. The microprocessor is connected to a second motor driver and a second motor in turn, and then connected to the multi-way valve (5) for controlling one port in the multi-way valve connected to the injector to be in respective and corresponding communication with other ports in the multi-way valve (5). The colorimetric detector (11) is connected with the microprocessor.

### CROSS REFERENCE TO RELATED APPLICATIONS

This non-provisional patent application is a Continuation application of International Application PCT/CN2018/099845, filed on Aug. 10, 2018, which claims priority from Patent Application No. 201711260674.5 filed in The People's Republic of China on Dec. 4, 2017. These two applications are incorporated herein by reference.

### FIELD OF THE INVENTION

The present invention relates to a water quality analyzer, in particular to an in-situ analyzer for nutritive salt and a nutritive salt content analysis method.

### BACKGROUND OF THE INVENTION

Nutritive salt is a necessary material basis for marine phytoplankton to grow. The different concentrations and composition of nutritive salt in seawater affect the primary productivity of the oceans and regulate the community structure of phytoplankton, thus affecting the structure of marine ecosystems. In normal seawater, proper nutritive salt can the reproduction and growth of organisms. However, excessive nutritive salt can promote the rapid reproduction of certain marine organisms, thus consuming large amounts of dissolved oxygen in seawater and causing oxygen deficiency in seawater, thereby causing a large number of fish, shrimps, crabs and shellfish died. The pollution of the oceans by organic matter and nutritive salt is now called eutrophication. Understanding the spatial and temporal distribution and changes of nutritive salt in the ocean is of great significance for understanding the key processes of marine ecosystems, evaluating and controlling the eutrophication of marine waters. Nutritive salt in seawater is a necessary ingredient for marine phytoplankton to grow and reproduce, and is the basis for marine primary productivity and the food chain. Therefore, the content of nutritive salt in seawater is an important parameter for marine ecological environment monitoring and one of the marine regular projects for marine monitoring.

The commonly used measurement method for traditional seawater nutrients is based on the on-site sampling of the survey vessel, then returned to a laboratory for measurement. The method has shortcomings such as poor real-time performance, waste of manpower, financial resources and time. Secondly, the sample is susceptible to pollution, and the measurement error caused by the processes of collection, pretreatment, loading, transportation, etc. can reach −20% to +45%. Moreover, continuous data cannot be provided. Besides, it is difficult to detect drastic changes in the concentration of nutritive salt caused by intermittent events such as rainfall and algal blooms. Marine monitoring studies over the past few decades have confirmed that traditional methods are no longer sufficient to meet realistic demand. There is an urgent need to solve the problems of the complicated process, consumables, off-line analysis, and inability to meet low-content measurement requirements of the existing seawater nutrient analyzer. Therefore, it is important to develop an on-line analyzer with compact design of structure, good water tightness, high resolution, high reliability, low detection limit and capable of analyzing low-content seawater nutrients. The analyzer of seawater nutrients also can provide on-site data in real time, timely grasp the changes of marine ecological environment and degree of eutrophication, make quick decisions and study temporal and spatial variations of the ocean at different scales.

The measurement and analysis of seawater nutrients in China is carried out according to the method specified in Marine Monitoring Code. That is, traditional sampling and laboratory analysis are used. The method of traditional laboratory analysis and measurement has the following defects: poor representativeness of samples, sample contamination during collection and pretreatment, loss and variation of nutritive salt during preservation and transportation, etc. Besides, the method cannot meet on-site continuous monitoring, and increasingly urgent need for disaster prevention and mitigation and scientific research.

In order to develop on-site monitoring technology for seawater nutrients, China Ocean Technology Research Institute has carried out research of monitoring technology on nutritive salt with the support of 863-818 fund. At present, prototypes of separating and on-site automatic analyzer have been developed. There are three types of single-machine models, such as on-site automatic phosphate analyzer, on-site automatic nitrite analyzer and on-site automatic nitrate analyzer. However, there is no automatic on-line seawater nutrient analyzer that can realize multi-component analysis.

### SUMMARY OF THE INVENTION

A first objective of the present invention is to overcome the shortcomings and deficiencies of the prior art, and to provide an in-situ analyzer for nutritive salt with simple structure, strong function, strong applicability and high reliability. The in-situ analyzer for nutritive salt can be continuously and automatically sampling and analyze the content of nutritive salt, and can achieve on-line analysis of multiple components.

A second objective of the present invention is to provide a nutritive salt content analysis method.

The first objective of the present invention is achieved by the following technical solutions: An in-situ analyzer for a nutritive salt comprising a microprocessor, a drive component, a multi-way valve with a plurality of ports, an injector, a colorimetric detector, a mixing ring, a sample pipeline, a pure water bin, a standard solution bin, and various reagent bins, wherein the injector, the colorimetric detector, the mixing ring, the sample pipeline, the pure water bin, the standard solution bin and the various reagent bins are respectively connected to corresponding ports of the multi-way valve;

the driving component comprises a first motor driver, a first motor, a second motor driver and a second motor; the microprocessor is connected to the first motor driver and the first motor in turn, and then connected to an injection pump of the injector for controlling the operation of the injection pump; the microprocessor is connected to the second motor driver and the second motor in turn, and then connected to the multi-way valve for controlling one port in the multi-way valve connected to the injector to be in respective and corresponding communication with other ports in the multi-way valve; and

the colorimetric detector is connected with the microprocessor and configured to send a detection signal to the microprocessor such that the microprocessor judges the nutritive nutrient salt content of the sample according to the detection signal.

Preferably, the in-situ analyzer further comprises a waste liquid collecting device and a cadmium column, and the waste liquid collecting device and the cadmium column are respectively connected to corresponding ports of the multi-way valve.

Preferably, the colorimetric detector includes a light source, a colorimetric cell, a coupling lens and a photoelectric converter; the light source and the coupling lens are respectively arranged at opposite ends of the colorimetric cell; the photoelectric converter is connected to the microprocessor and disposed at a light emitting end of the coupling lens; and in the colorimetric detector, the colorimetric cell is connected and communicated with one port of the multi-way valve.

Preferably, the light source is a composite LED light source; or the colorimetric cell is a quartz flow cell with the optical path of 1 cm.

Preferably, the sample channel is a Teflon tube; or the multi-way valve is a valve with 8-24 ways.

Preferably, the sample channel is a tube with PTFE; or the multi-way valve is a valve with 16 ways.

Preferably, the microprocessor communicates with a intelligent terminal through a wireless communication module or a signal line.

Preferably, the in-situ analyzer further includes a water-proof protective shell and an upper protective cover, the upper protective cover sealing cover the water-proof protective shell;

the water-proof protective shell is divided into upper and lower cabins which are a waterway protective cabin and a circuit protective cabin respectively by a middle separating layer; wherein the microprocessor, the first motor driver and the second motor driver are all placed in the circuit protective cabin; the multi-way valve, the injector, the injection pump, the first motor, the second motor, the colorimetric detector and the mixing ring are all placed in the waterway protective cabin;

a protective bin is placed above the upper protective cover; the pure water bin, the standard solution bin and various reagent bins are all arranged in the protective bin; a pure water pipeline connected with the pure water bin, a standard solution pipeline connected with the standard solution bin and various reagent pipelines connected with the various reagent bins pass through the protective bin and the upper protective cover, and then respectively and correspondingly connected with various ports of the multi-way valve; and

one end of the sample pipeline is connected with one port of the multi-way valve; the other end thereof passes through the upper protective cover and is arranged outside the water-proof protective shell.

Preferably, the water-proof protective shell is mounted in a marine buoy monitoring system; the microprocessor in the circuit protective cabin communicates with a buoy data collector in the marine buoy monitoring system through a signal line or a wireless communication module; the buoy data collector controls the microprocessor to start analysis processing every certain time; meanwhile, the buoy data collector collects a data signal of nutritive salt content of the sample judged by the microprocessor, and transmits the data signal of nutritive salt content to a data center of the marine buoy monitoring system through a wireless communication network.

Preferably, the in-situ analyzer further comprises a waste liquid collecting device connected to one port of the multi-way valve; and the waste liquid collecting device is arranged outside the water-proof protective shell.

Preferably, the in-situ analyzer further comprises a waste liquid collecting device connected to one port of the multi-way valve; and the waste liquid collecting device is arranged above the upper protective cover.

Preferably, the in-situ analyzer further comprises a waste liquid collecting device connected to one port of the multi-way valve; a waste water pipeline connected with the waste liquid collecting device passes through the upper protective cover and is connected with one port of the multi-way valve.

The second objective of the present invention is achieved by the following technical solutions: a nutritive salt content analysis method, when a sample is required to be mixed with a certain reagent to obtain the corresponding nutritive salt content of the sample, the method comprising:

step A1, the microprocessor obtaining detection signals when pure water and various standard solutions are respectively mixed with a certain reagent;

step A2, when analyzing the nutritive salt content of the sample, mixing the sample with a certain reagent to obtain a third detection signal;

step A3, the microprocessor respectively obtaining the first detection signal sent by the colorimetric detector when the pure water is mixed with a certain reagent, the second detection signal sent by the colorimetric detector when each standard solution is mixed with the certain reagent, and the third detection signal sent by the colorimetric detector when the sample is mixed with the certain reagent, comparing the third detection signal with the first detection signal and each second detection signal, and obtaining corresponding nutritive salt content in the sample according to the comparison result.

Preferably, the process of obtaining a detection signal when pure water is mixed with a certain reagent comprises:

step a11, pure water injected into the pure water bin, the microprocessor controlling the port of the multi-way valve connected with the injector to be in communication with the port of the multi-way valve connected with the pure water bin through the second motor, then the microprocessor controlling the operation of the injection pump through the first motor to pump a corresponding amount of pure water into the injector;

the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;

step a12, the microprocessor controlling the port of the multi-way valve connected with the injector to be in communication with the port of the multi-way valve connected with the mixing ring through the second motor; then the microprocessor controlling the operation of the injection pump through the first motor to continuously inject and discharge the reagent and pure water in the injector from the mixing ring so as to mix pure water and the reagent; pumping a first mixture of the reagent and pure water into the injector after mixing;

step a13, the microprocessor controlling the port of the multi-way valve connected with the injector to be in communication with the port of the multi-way valve connected with the colorimetric detector through the second motor; and then the microprocessor controlling the operation of the injection pump through the first motor to pump the first mixture in the injector into the colorimetric detector;

step a14, the colorimetric detector detecting the first mixture pumped and sending a first detection signal detected to the microprocessor; or,

wherein the procedure for obtaining a certain detection signal when each standard solution is mixed with a certain reagent comprises:

step a21, the microprocessor controlling the port of the multi-way valve connected with the injector to be in communication with the port of the multi-way valve connected with the standard solution bin through the second motor; then the microprocessor controlling the operation of the injection pump through the first motor to pump a corresponding amount of standard solution into the injector;

the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;

step a22, the microprocessor controlling the port of the multi-way valve connected with the injector to be in communication with the port of the multi-way valve connected with the mixing ring through the second motor; then the microprocessor controlling the injection pump through the first motor to continuously inject and discharge the reagent and the standard solution in the injector from the mixing ring so as to mix the standard solution and the reagent; pumping a second mixture of the standard solution and the reagent into the injector after mixing;

step a23, the microprocessor controlling the port of the multi-way valve connected with the injector to be in communication with the port of the multi-way valve connected with the colorimetric detector through the second motor; then the microprocessor controlling the operation of the injection pump through the first motor, and injecting the second mixture in the injector into the colorimetric detector;

step a24, the colorimetric detector detecting the second mixture pumped and sending a second detection signal detected to the microprocessor; wherein standard solutions with various concentrations are respectively pumped into the standard solution bin in sequence; and each standard solution and a certain reagent are respectively mixed through the above steps to obtain each second detection signal after each standard solution is mixed with the certain reagent.

Preferably, specific process of the step A2 comprises:

step a31, the microprocessor controlling the port of the multi-way valve connected with the injector to be in communication with the port of the multi-way valve connected with the sample channel through the second motor; then the microprocessor controlling the operation of the injection pump through the first motor to pump a corresponding amount of the sample into the injector;

the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;

step a32, the microprocessor controlling the port of the multi-way valve connected with the injector to be in communication with the port of the multi-way valve connected with the mixing ring through the second motor; then the microprocessor controlling the injection pump through the first motor to continuously inject and discharge the reagent and the sample in the injector from the mixing ring so as to mix the sample and the reagent; pumping a third mixture of the sample and the reagent into the injector after mixing;

step a33, the microprocessor controlling the port of the multi-way valve connected with the injector to be in communication with the port of the multi-way valve connected with the colorimetric detector through the second motor; then the microprocessor controlling the operation of the injection pump through the first motor to pump the third mixture in the injector into the colorimetric detector;

step a34, the colorimetric detector detecting the third mixture pumped and sending a third detection signal detected to the microprocessor; or

when a sample is required to be mixed with several reagents to obtain the corresponding nutritive salt content in the sample, the method comprises:

step B1, the microprocessor obtaining detection signals when pure water is mixed with some certain reagents and detection signals when various standard solutions are respectively mixed with the some certain reagents;

step B2, when analyzing the nutritive salt content of the sample, mixing the sample and some certain reagents to obtain a sixth detection signal;

step B3, the microprocessor respectively obtaining fourth detection signals sent by the colorimetric detector when pure water is mixed with the some certain reagents, each fifth detection signal sent by the colorimetric detector when each standard solution is respectively mixed with the some certain reagents, and the sixth detection signals sent by the colorimetric detector when the sample is mixed with the some certain reagents, comparing the sixth detection signals, the fourth detection signals and each fifth detection signal, and obtaining the corresponding nutritive salt content in the sample according to the comparison result.

Preferably, process of obtaining detection signals when pure water is mixed with the some certain reagents comprises:

step b11, the microprocessor controlling the port of the multi-way valve connected with the injector to be in communication with the port of the multi-way valve connected with the pure water bin through the second motor; then the microprocessor controlling the operation of the injection pump through the first motor to pump a corresponding amount of pure water into the injector;

aiming at each reagent bin for storing each reagent correspondingly needing to be mixed with pure water, the microprocessor controlling ports in the multi-way valve connected with reagent bins to be respectively in communication with the port in the multi-way valve connected with the injector through the second motor at each moment; wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector;

step b12, the microprocessor controlling the port of the multi-way valve connected with the injector to be in communication with the port of the multi-way valve connected with the mixing ring through the second motor; then the microprocessor controlling the operation of the injection pump through the first motor to continuously inject and discharge pure water and various reagents in the injector from the mixing ring so as to mix pure water and the various reagents; pumping a fourth mixture of pure water and the various reagents into the injector after mixing;

step b13, the microprocessor controlling the port of the multi-way valve connected with the injector to be in communication with the port of the multi-way valve connected with the colorimetric detector through the second motor; then the microprocessor controlling the operation of the injection pump through the first motor to pump the fourth mixture in the injector into the colorimetric detector;

step b14, the colorimetric detector detecting the fourth mixture pumped and sending a fourth detection signal detected to the microprocessor; or,

process of obtaining detection signals when each standard solution is respectively mixed with some certain reagents comprises:

step b21, the microprocessor controlling the port of the multi-way valve connected with the injector to be in communication with the port of the multi-way valve connected with the standard solution bin through the second motor; then the microprocessor controlling the injection pump through the first motor to pump a corresponding amount of standard solution into the injector;

aiming at each reagent bin for storing each reagent correspondingly needing to be mixed with standard solution, the microprocessor controlling ports in the multi-way valve connected with reagent bins to be respectively in communication with the port in the multi-way valve connected with the injector through the second motor at each moment; wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector;

step b22, the microprocessor controlling the port of the multi-way valve connected with the injector to be in communication with the port of the multi-way valve connected with the mixing ring through the second motor; then the microprocessor controlling the operation of the injection through the first motor to continuously inject and discharge standard solution and various reagents in the injector from the mixing ring so as to mix the standard solution and the various reagents; pumping a fifth mixture of the standard solution and the various reagents into the injector after mixing;

step b23, the microprocessor controlling the port of the multi-way valve connected with the injector to be in communication with the port of the multi-way valve connected with the colorimetric detector through the second motor; then the microprocessor controlling the operation of the injection pump through the first motor to pump the fifth mixture in the injector into the colorimetric detector;

step b24, the colorimetric detector detecting the fifth mixture pumped and sends a fifth detection signal detected to the microprocessor; wherein standard solutions with various concentrations are respectively pumped into the standard solution bin in sequence; and each standard solution is respectively mixed with some certain reagents through the above steps to obtain each fifth detection signal after each standard solution is mixed with the some certain reagents; or,

specific process of the step B2 comprises:

step b31, the microprocessor controlling the port of the multi-way valve connected with the injector to be in communication with the port of the multi-way valve connected with the sample channel through the second motor; then the microprocessor controlling the operation the injection pump through the first motor to pump a corresponding amount of sample into the injector;

aiming at each reagent bin for storing each reagent correspondingly needing to be mixed with the sample, the microprocessor controlling ports in the multi-way valve connected with reagent bins to be respectively in communication with the port in the multi-way valve connected with the injector through the second motor at each moment; wherein when the port of the multi-way valve connected to one of the reagent bins is in communication with the port of the multi-way valve connected with the injector each time, the microprocessor controls the operation of the injection pump through the first motor to pump a corresponding amount of the reagent in the corresponding reagent bin into the injector;

step b32, the microprocessor controlling the port of the multi-way valve connected with the injector to be in communication with the port connected with the mixing ring through the second motor; then the microprocessor controlling the injection pump through the first motor to continuously inject and discharge the sample and various reagents in the injector from the mixing ring so as to mix the sample and the various reagents; pumping a sixth mixture of the sample and the various reagents into the injector after mixing;

step b33, the microprocessor controlling the port of the multi-way valve connected with the injector to be in communication with the port of the multi-way valve connected with the colorimetric detector through the second motor; then the microprocessor controlling the operation of the injection pump through the first motor to pump the sixth mixture in the injector into the colorimetric detector;

step b34, the colorimetric detector detecting the sixth mixture pumped, and sending a sixth detection signal detected to the microprocessor.

Preferably, when the nitrate content in the sample needs to be detected, steps thereof comprise:

step C1, the microprocessor obtaining detection signals when pure water is mixed with a buffer solution and detection signals when various standard solutions are respectively mixed with a buffer solution;

step C2, when nitrate in the sample needs to be detected, mixing the sample and the buffer solution to obtain a ninth detection signal;

step C3, the microprocessor respectively obtaining the seventh detection signals sent by the colorimetric detector when the pure water is mixed with the buffer solution, the eighth detection signal sent by the colorimetric detector when each standard solution is mixed with the buffer solution and the ninth detection signal sent by the colorimetric detector when the sample is mixed with the buffer solution, comparing the ninth detection signal with the seventh detection signal and each eighth detection signal, and obtaining the corresponding nitrate content in the sample according to the comparison result.

Preferably, the process of obtaining the detection signal when the pure water is mixed with the buffer solution comprising:

step c11, the microprocessor controlling the port of the multi-way valve connected with the injector to be in communication with the port of the multi-way valve connected with the pure water bin through the second motor; then the microprocessor controlling the operation of the injection pump through the first motor to pump a corresponding amount of pure water into the injector;

the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;

step c12, the microprocessor controlling the port in the multi-way valve connected with the injector to be in communication with the port connected with the mixing ring through the second motor; then the microprocessor controlling the operation of the injection pump through the first motor to continuously inject and discharge pure water and the buffer solution in the injector from the mixing ring and pump out the mixing ring so as to mix pure water and the buffer solution; pumping a seventh mixture of pure water and the buffer solution into the injector after mixing;

step c13, the microprocessor controlling the port of the multi-way valve connected with the injector to be in communication with the port of the multi-way valve connected with the cadmium column through the second motor; then the microprocessor controlling the operation of the injection pump through the first motor to pump the seventh mixture in the injector into the cadmium column such that the cadmium column reduces the nitrate into nitrite; after waiting for a certain time, the microprocessor controlling the operation of the injection pump through the first motor to pump reduced solution reduced by the cadmium column into the injector;

step c14, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution in the injector into the colorimetric detector;

step c15, the colorimetric detector detecting the reduced solution pumped and sends a seventh detection signal detected to the microprocessor; or,

process of obtaining a detection signal when each standard solution is mixed with a buffer solution comprises:

step c21, the microprocessor controlling the port of the multi-way valve connected with the injector to be in communication with the port of the multi-way valve connected with the standard solution bin through the second motor; then the microprocessor controlling the injection pump through the first motor to pump a corresponding amount of standard solution into the injector;

the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;

step c22, the microprocessor controlling the port in the multi-way valve connected with the injector to be in communication with the port connected with the mixing ring through the second motor; then the microprocessor controlling the operation of the injection pump through the first motor to continuously inject and discharge standard solution and buffer solution in the injector from the mixing ring so as to mix the standard solution and the buffer solution; pumping an eighth mixture of the standard solution and the buffer solution into the injector after mixing;

step c23, the microprocessor controlling the port of the multi-way valve connected with the injector to be in communication with the port of the multi-way valve connected with the cadmium column through the second motor; then the microprocessor controlling the operation of the injection pump through the first motor to inject the eighth mixture in the injector into the cadmium column, and the cadmium column reducing the nitrate into nitrite; after waiting for a certain time, the microprocessor controlling the operation of the injection pump through the first motor to pump reduced solution reduced by the cadmium column into the injector;

step c24, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution by cadmium column in the injector into the colorimetric detector;

step c25, the colorimetric detector detecting the reduced solution by cadmium column and sends an eighth detection signal detected to the microprocessor;

wherein the standard solutions with various concentrations are respectively injected into the standard solution bin in sequence; and each standard solution and the buffer solution are respectively mixed through the above steps to obtain each eighth detection signal after each standard solution is mixed with the buffer solution.

Preferably, specific steps of the steps C2 comprises:

step c31, the microprocessor controlling the port of the multi-way valve connected with the injector to be in communication with the port of the multi-way valve connected with the sample channel through the second motor; the microprocessor controlling the operation of the injection pump through the first motor to pump a corresponding amount of the sample into the injector;

the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;

step c32, the microprocessor controlling the port in the multi-way valve connected with the injector to be in communication with the port connected with the mixing ring through the second motor; then the microprocessor controlling the operation of the injection pump through the first motor to continuously inject and discharge the sample and the buffer solution in the injector from the mixing ring so as to mix the sample and the buffer solution; pumping a ninth mixture of the sample and the buffer solution into the injector after mixing;

step c33, the microprocessor controlling the port of the multi-way valve connected with the injector to be in communication with the port of the multi-way valve connected with the cadmium column through the second motor; then the microprocessor controlling the operation of the injection pump through the first motor to inject the ninth mixture in the injector into the cadmium column, and the cadmium column reducing the nitrate into nitrite; after waiting for a certain time, the microprocessor controlling the operation of the injection pump through the first motor to pump reduced solution reduced by the cadmium column into the injector;

step c34, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution reduced by the cadmium column in the injector into the colorimetric detector;

step c35, the colorimetric detector detecting the reduced solution pumped and sending a ninth detection signal detected to the microprocessor.

Preferably, when the waste liquid in the colorimetric detector needs to be recovered, specific steps comprise:

step D1, the microprocessor controlling the port of the multi-way valve connected with the injector to be in communication with the port of the multi-way valve connected with the colorimetric detector through the second motor; then the microprocessor controlling the operation of the injection pump through the first motor to pump the solution in the colorimetric detector into the injector;

step D2, the microprocessor controlling the port of the multi-way valve connected with the injector to be in communication with the port of the multi-way valve connected with the waste liquid collecting device through the second motor; then the microprocessor controlling the operation of the injection pump through the first motor to inject the solution in the injector into the waste liquid collecting device;

step D3, the microprocessor controlling the port of the multi-way valve connected with the injector to be in communication with the port of the multi-way valve connected with the pure water bin through the second motor; then the microprocessor controlling the operation of the injection pump through the first motor to pump the pure water in the pure water bin into the injector;

step D4, the microprocessor controlling the port of the multi-way valve connected with the injector to be in communication with the port of the mixing ring through the second motor; then the microprocessor controlling the injection pump through the first motor to continuously inject and discharge pure water in the injector from the mixing ring to clean the mixing ring and the injector through pure water, and finally pumps cleaned solution into the injector; then the microprocessor controlling the port of the multi-way valve connected with the injector to be in communication with the port of the multi-way valve connected with the waste liquid collecting device through the second motor; then the microprocessor controlling the operation of the injection pump through the first motor to pump the solution in the injector into the waste liquid collecting device.

Compared with the prior art, the invention has the following advantages and effects that:

(1) the in-situ analyzer for nutritive salt of the present invention includes a microprocessor, a drive component, a multi-way valve with a plurality of ports, an injector, a colorimetric detector, a mixing ring, a sample pipeline, a pure water bin, a standard solution bin, and various reagent bins. The injector, the colorimetric detector, the mixing ring, the sample pipeline, the cadmium column, the waste liquid collecting device, the pure water bin, the standard solution bin and the various reagent bins are respectively connected to corresponding any other port of the multi-way valve. The microprocessor can control the port in the multi-way valve connected to the injector to be in communication with any other port in the multi-way valve through the second motor. And the microprocessor can control the operation of the injection pump through the first motor so as to control solution in the injector to be pumped in or discharged out. In the present invention, when the port in the multi-way valve connected to the injector to be in communication with any other port in the multi-way valve, the microprocessor can control the operation of the injection pump so that the injector pumps in or discharges out the solution from the corresponding port in the multi-way valve.

Thus, the present invention can mix pure water, standard solution or sample with any one or more reagents through the control of the microprocessor, injecting the final mixed solution into the colorimetric detector for detection. The microprocessor can finally obtain the nutritive salt content of the sample according to the detection signal of the colorimetric detector.

As can be seen from the foregoing, in the present invention, as long as one end of a sample channel is placed in a sample and various reagent bins are filled with corresponding reagents, the on-line continuous sampling and analysis of the nutritive salt content of the sample can be realized through the control of the microprocessor. In addition, various reagent bins in the present invention are respectively connected with ports of the multi-way valve. Therefore, the microprocessor can mix pure water, standard solution or sample with any one or more reagents according to actual analysis requirement so as to achieve on-line analysis of multiple components.

Therefore, the multi-way valve is used as a positioning system, the injector is used as a core power part to achieve the analysis of the nutritive salt content in the present invention with the advantages of simple structure, strong function, strong applicability and high reliability.

(2) In the in-situ analyzer for nutritive salt of the present invention, one port of the multi-way valve is connected with a mixing ring. When one of pure water, standard solution and the sample, and at least one reagent have been pumped into the injector, the microprocessor controls the port in the multi-way valve connected to the injector to be in communication with the port in the multi-way valve connected with the mixing ring. Then the microprocessor controls the operation of the injection pump so as to control solution in the injector to be continuously pumped in or discharged out from the mixing ring. Therefore one of pure water, standard solution and the sample, and at least one reagent can be sufficiently and uniformly mixed, improving the accuracy of detecting the nutritive salt content of the sample.

(3) In the in-situ analyzer for nutritive salt of the present invention, the microprocessor can control the operation of the first motor connected to the injection pump so that the injector can inject a corresponding amount of pure water, standard solution, the sample or the reagent. Therefore the in-situ analyzer for nutritive salt in the present invention can flexibly control sample quantity and reagent quantity through the microprocessor, so that the nutritive salt content can be efficiently, stably and accurately detected.

(4) In the in-situ analyzer for nutritive salt of the present invention, one port of the multi-way valve is connected with a waste liquid collecting device. Thus for solution that have been detected by the colorimetric detector, the microprocessor controls the multi-way valve and the injection pump so as to discharge out the solution in the colorimetric cell of the colorimetric detector to the waste liquid collecting device and avoid to process the pollution of wasted liquid.

In addition, one port of the multi-way valve is connected with the cadmium column, when nitrate analysis is needed to be carried out on a sample, the microprocessor can control the multi-way valve and the injection pump to pump a mixed solution of the sample and the buffer solution into the cadmium column, and the cadmium column reduces nitrate in the sample into nitrite. Finally, the microprocessor controls the multi-way valve and the injection pump to pump reduced solution reduced by the cadmium column into the colorimetric detector for final detection, so that the in-situ analyzer for nutritive salt of the present invention can be used for analyzing nitrate of a sample at the same time.

(5) In the in-situ analyzer for nutritive salt of the present invention, the colorimetric detector includes a light source, a colorimetric cell, a coupling lens and a photoelectric converter. The light source and the coupling lens are respectively arranged at opposite ends of the colorimetric cell. And the coupling lens can be used for coupling and focusing the light, so as to reduce the loss of optical signals. In addition, the light source can be a composite LED light source so as to achieve a cold light source with low power consumption, and effectively avoid the heating phenomenon of the in-situ analyzer for nutritive salt.

In the present invention, the colorimetric cell is a quartz flow cell with the optical path of 1 cm, meeting the aim of long-optical-path in-situ monitoring, and facilitating trace sample analysis of a low-concentration sample.

(6) The in-situ analyzer for nutritive salt of the present invention includes a water-proof protective shell and an upper protective cover sealing cover the water-proof protective shell. Wherein the water-proof protective shell is divided into upper and lower cabins by a middle separating layer. The upper and lower cabins are a waterway protective cabin and a circuit protective cabin respectively. Wherein the microprocessor, the first motor driver and the second motor driver are all placed in the circuit protective cabin. The multi-way valve, the injector, the injection pump, the first motor, the second motor, the colorimetric detector and the mixing ring are all placed in the waterway protective cabin. Various reagent bins are all arranged above the upper protective cover and are connected with all ports of the multi-way valve through various reagent pipelines. The pipeline and various reagent pipelines pass through the upper protective cover and the passing positions are sealed.

Therefore, the in-situ analyzer for nutritive salt of the present invention can be integrated into one water-proof protective shell, so that the in-situ analyzer is simpler in structure, smaller in size and more portable. In addition, the waterproof protective shell separates the waterway protective bin from the circuit protective cabin, so that the circuit protective cabin has moisture-proof and moisture-proof functions, and electric leakage is effectively avoided.

(7) In the in-situ analyzer for nutritive salt of the present invention, when the in-situ analyzer is integrated into one water-proof protective shell, the in-situ analyzer can be can be used for completing analysis and measurement independently in laboratories or outdoors by using an external 12V direct current power supply. And the in-situ analyzer also can be directly mounted on a marine buoy monitoring system, and the electrical power of the in-situ analyzer is provided by the buoy 12V lead-acid battery to complete analysis and measurement. When the in-situ analyzer is mounted on a marine buoy monitoring system, the microprocessor of the present invention can communicate with a buoy data collector in the marine buoy monitoring system through a signal line or a wireless communication module. The buoy data collector can control the microprocessor to start analysis processing every certain time. Meanwhile, the buoy data collector collects a data signal of nutritive salt content of the sample judged by the microprocessor. And the buoy data collector transmits the data signal of nutritive salt content to a data center of the marine buoy monitoring system through a wireless communication network, such as GPRS (General Packet Radio Service) or Beidou satellites), to thereby realize long-term stable real-time measurement of seawater nutrients.

### BRIEF DESCRIPTION OF THE DRAWINGS

FIG. 1 is a schematic structural view of the in-situ analyzer for a nutritive salt in the present invention.

FIG. 2 is a circuit schematic diagram of the in-situ analyzer for a nutritive salt in the present invention.

FIG. 3 is a schematic diagram of the colorimetric detector in the in-situ analyzer for a nutritive salt in the present invention.

FIG. 4 is a schematic structural view of the structure of the in-situ analyzer for a nutritive salt integrated into a water-proof protective shell.

### DETAILED DESCRIPTION OF THE PREFERRED EMBODIMENTS

Below, the present invention will be described in greater detail with reference to the embodiments and the drawings, but the embodiments of the present invention are not limited thereto.

### Embodiments

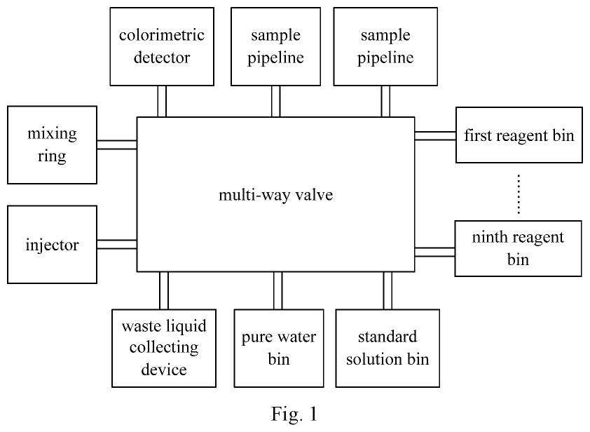

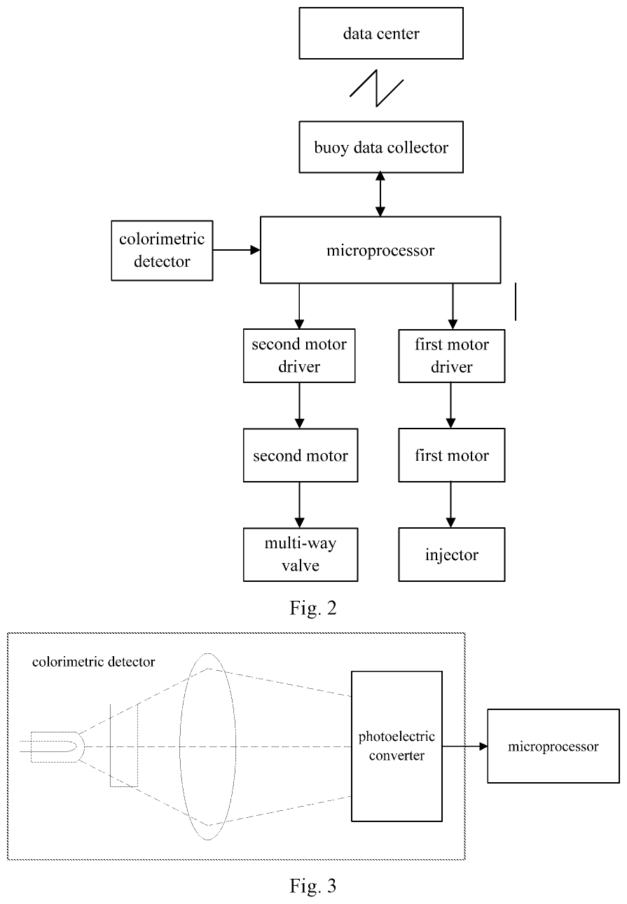

In an embodiment of the present invention, an in-situ analyzer includes a microprocessor, a drive component, a multi-way valve with a plurality of ports, an injector, a colorimetric detector, a mixing ring, a sample pipeline, a cadmium column, a waste liquid collecting device, a pure water bin, a standard solution bin, and various reagent bins. As shown in FIG. 1, the injector, the colorimetric detector, the mixing ring, the sample pipeline, the cadmium column, the waste liquid collecting device, the pure water bin, the standard solution bin and the various reagent bins are respectively connected to corresponding ports of the multi-way valve. In the embodiment, as shown in FIG. 2, the driving component includes a first motor driver, a first motor, a second motor driver, and a second motor. The microprocessor is connected to the first motor driver and the first motor in turn, and then connected to an injection pump of the injector for controlling the operation of the injection pump. The microprocessor is connected to the second motor driver and the second motor in turn, and then connected to the multi-way valve for controlling one port in the multi-way valve connected to the injector to be in respective and corresponding communication with other ports in the multi-way valve. The colorimetric detector is connected with the microprocessor and configured to send a detection signal to the microprocessor such that the microprocessor judges the nutritive nutrient salt content of the sample according to the detection signal.

In the embodiment, the microprocessor can control the port in the multi-way valve connected to the injector to be in communication with any other port in the multi-way valve through the second motor. And the microprocessor can control the operation of the injection pump through the first motor so as to control solution in the injector to be pumped in or discharged out. When the port in the multi-way valve connected to the injector to be in communication with any other port in the multi-way valve, the microprocessor can control the operation of the injection pump so that the injector pumps in or discharges out the solution from the corresponding port in the multi-way valve. Thus, the embodiment can mix pure water, standard solution or sample with any one or more reagents through the control of the microprocessor, injecting the final mixed solution into the colorimetric detector for detection. The microprocessor can finally obtain the nutritive salt content of the sample according to the detection signal of the colorimetric detector. For example, when the sample needs to be mixed with a certain reagent to detect a certain nutritive salt content, firstly, the microprocessor obtains all kinds of detection signals outputted from the colorimetric detector when pure water and various standard solutions are mixed with a certain reagent respectively, compared the above all kinds of detection signals with the detection signal outputted from the colorimetric detector when a sample is mixed with a certain reagent, so as to obtain the certain nutritive salt content of the sample. Similarly, when the sample needs to be mixed with a plurality of reagents to detect a certain nutritive salt content, firstly, the microprocessor obtains all kinds of detection signals outputted from the colorimetric detector when pure water and various standard solutions are mixed with a plurality of reagents respectively, compared the above all kinds of detection signals with the detection signal outputted from the colorimetric detector when a sample is mixed with a plurality of reagents, so as to obtain the certain nutritive salt content of the sample.

As can be seen from the foregoing, in the embodiment, the microprocessor obtains detection signals outputted from the colorimetric detector when pure water and various standard solutions are mixed with all kinds of reagents respectively, and detection signals outputted from the colorimetric detector when pure water and various standard solutions are mixed with a plurality of reagents. Then as long as one end of a sample channel is placed in a sample and various reagent bins are filled with corresponding reagents, the on-line continuous sampling and analysis of the nutritive salt content of the sample can be realized through the control of the microprocessor.

In the in-situ analyzer for nutritive salt of the embodiment, one port of the multi-way valve is connected with a mixing ring. When a sample and at least one reagent have been pumped into the injector, the microprocessor controls the port in the multi-way valve connected to the injector to be in communication with the port in the multi-way valve connected with the mixing ring. Then the microprocessor controls the injection pump to operate so as to control solution in the injector to be continuously pumped in or discharged out from the mixing ring. Therefore the sample and at least one reagent can be sufficiently and uniformly mixed, improving the accuracy of detecting the nutritive salt content of the sample. Besides, the microprocessor can control the first motor connected to the injection pump so that the injector can inject the corresponding amount of the sample or the reagent. Therefore the in-situ analyzer for nutritive salt of the embodiment can flexibly control sample quantity and reagent quantity through the control program of the first motor set in the microprocessor, so that the nutritive salt content can be efficiently, stably and accurately detected.

In the embodiment, as shown in FIG. 3, the colorimetric detector includes a light source, a colorimetric cell, a coupling lens and a photoelectric converter. The light source and the coupling lens are respectively arranged at opposite ends of the colorimetric cell. The photoelectric converter is connected to the microprocessor and disposed at a light emitting end of the coupling lens. And in the colorimetric detector, the colorimetric cell is connected and communicated with one port of the multi-way valve. Wherein the specific detection work of the colorimetric detector after the solution enters the colorimetric detector is as follows: when the solution in the injector enters the colorimetric cell of in the colorimetric detector, light emitted by the light source passes through the colorimetric cell and then reaches the coupling lens. The coupling lens carries out coupling processing on the light and then transmits the light after coupling processing to the photoelectric converter. The photoelectric converter converts a received light signal into an electric signal and then transmits the electric signal to the microprocessor. And the microprocessor judges the nutritive nutrient salt content of the sample according to the received electric signal.

In the embodiment, the light source adopts a composite LED light source so as to achieve a cold light source with low power consumption, and effectively avoid the heating phenomenon of the in-situ analyzer for nutritive salt. In the embodiment, the colorimetric cell is a quartz flow cell with the optical path of 1 cm, meeting the aim of long-optical-path in-situ monitoring, and facilitating trace sample analysis of a low-concentration sample.

In this embodiment, the sample channel is a Teflon tube. In the embodiment, the multi-way valve is selected according to ports of the injector, the colorimetric detector, the mixing ring, the sample pipeline, the cadmium column, the waste liquid collecting device, the pure water bin, the standard solution bin and various reagent bins which need to be connected in total, generally a valve with 8-24 ways. In the embodiment, as shown in FIG. 1, when nine reagent bins are included, first reagent bin to ninth reagent bin respectively, the multi-way valve is a valve with 16 ways. The microprocessor controls the port of the valve with 16 ways connected to the injector to be in communication with any other port of the valve with 16 ways connected with the colorimetric detector, the mixing ring, the sample pipeline, the cadmium column, the waste liquid collecting device, the pure water bin, the standard solution bin and the nine reagent bins through the second motor.

In the embodiment, the microprocessor communicates with a intelligent terminal through a wireless communication module or a signal line. The microprocessor sends data signal of the nutritive salt content of the sample to the intelligent terminal. Meanwhile the intelligent terminal also can control the microprocessor to start a analysis processing every certain time. So-called a analysis processing refers to the process of completing a detection of nutritive salt content in a sample. Each time the analysis processing is carried out, a solution obtained by mixing a sample with one or more reagents is required to be injected into the colorimetric detector. And when the next analysis processing is required to be carried out, a solution obtained by mixing the sample with one or more reagents is required to be injected into the colorimetric detector again.

In addition, the intelligent terminal can download a corresponding control program of the first motor and the second motor to the microprocessor according to the analysis requirement of the nutritive salt, e.g. a required reagent mixed with the sample, the dosage of a required sample during mixing every time, the dosage of a reagent needed during mixing every time and so on. Thus, the microprocessor controls the first motor and the second motor, realizing the content analysis of corresponding nutritive salt.

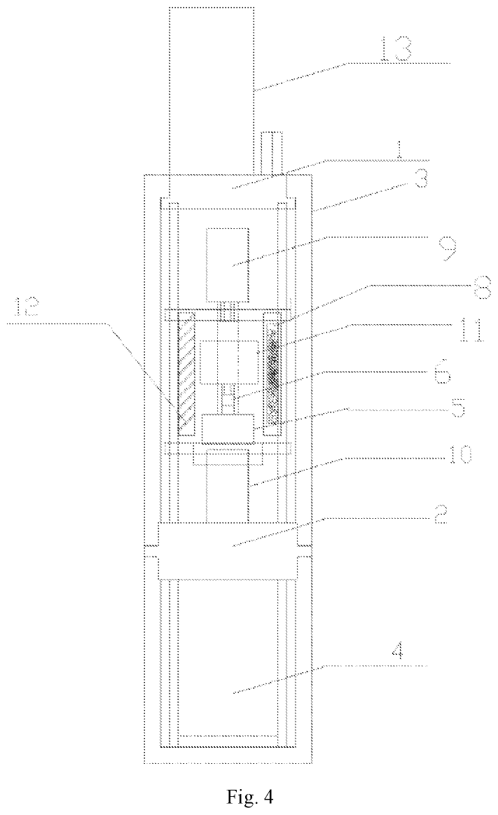

In the embodiment, as shown in FIG. 4, the in-situ analyzer also includes a water-proof protective shell and an upper protective cover 1, the upper protective cover 1 sealing cover the water-proof protective shell.

In the embodiment, the water-proof protective shell is divided into upper and lower cabins by a middle separating layer 2. The upper and lower cabins are a waterway protective cabin 3 and a circuit protective cabin 4 respectively. Wherein the microprocessor, the first motor driver and the second motor driver are all placed in the circuit protective cabin. The multi-way valve 5, the injector, the injection pump 6, the cadmium column 8, the first motor 9, the second motor 10, the colorimetric detector 11 and the mixing ring 12 are all placed in the waterway protective cabin.

In the embodiment, a protective bin 13 is placed above the upper protective cover. Wherein the pure water bin, the standard solution bin and various reagent bins are all arranged in the protective bin. And a pure water pipeline connected with the pure water bin, a standard solution pipeline connected with the standard solution bin and various reagent pipelines connected with the various reagent bins pass through the protective bin and the upper protective cover, and then respectively and correspondingly connected with various ports of the multi-way valve.

In the embodiment, one end of the sample pipeline is connected with one port of the multi-way valve. And the other end of the sample pipeline passes through the upper protective cover and is arranged outside the water-proof protective shell for taking samples outside the water-proof protective shell.

In the embodiment, the waste liquid collecting device is arranged outside the water-proof protective shell. The waste liquid collecting device can also be arranged above the upper protective cover. A waste water pipeline connected with the waste liquid collecting device passes through the upper protective cover and is connected with one port of the multi-way valve.

In the embodiment, the pure water pipeline, the standard solution pipeline, the sample pipeline, each reagent pipeline and the waste water pipeline pass through the upper protective cover for sealing treatment so as to ensure the water resistance. Each reagent pipeline passes through the protective bin for sealing treatment.

In the embodiment, the water-proof protective shell can be mounted in a marine buoy monitoring system. When the water-proof protective shell can be mounted in the marine buoy monitoring system, as shown in FIG. 2, the microprocessor in the circuit protective cabin communicates with a buoy data collector in the marine buoy monitoring system through a signal line or a wireless communication module. The buoy data collector controls the microprocessor to start analysis processing every certain time. Meanwhile, the buoy data collector collects a data signal of nutritive salt content of the sample judged by the microprocessor. And the buoy data collector transmits the data signal of nutritive salt content to a data center of the marine buoy monitoring system through a wireless communication network, such as GPRS (General Packet Radio Service) or Beidou satellites to thereby realize long-term stable real-time measurement of seawater nutrients.

In the embodiment, the invention also discloses a nutritive salt content analysis method based on the in-situ analyzer for nutritive salt. When a sample is required to be mixed with a certain reagent to obtain the corresponding nutritive salt content of the sample, the method comprises step A1, step A2 and step A3.

In the step A1, the microprocessor obtaining detection signals when pure water and various standard solutions are respectively mixed with a certain reagent.

Wherein the process of obtaining a detection signal when pure water is mixed with a certain reagent comprises step a11, step a12, step a13 and step a14.

In the step a11, pure water is injected into the pure water bin, the microprocessor controls the port of the multi-way valve connected with the injector to be in communication with the port of the multi-way valve connected with the pure water bin through the second motor. Then the microprocessor controls the operation of the injection pump through the first motor to pump a corresponding amount of pure water into the injector.

The microprocessor controls the port of the multi-way valve connected with the injector to be in communication with the port of the multi-way valve connected with a certain reagent bin through the second motor. Then the microprocessor controls the operation of the injection pump through the first motor to pump a certain quantity of a corresponding reagent in the certain reagent bin into the injector.

In the step a12, the microprocessor controls the port of the multi-way valve connected with the injector to be in communication with the port of the multi-way valve connected with the mixing ring through the second motor. Then the microprocessor controls the operation of the injection pump through the first motor to continuously inject and discharge the reagent and pure water in the injector from the mixing ring so as to mix pure water and the reagent. Pumping a first mixture of the reagent and pure water into the injector after mixing.

In the step a13, the microprocessor controls the port of the multi-way valve connected with the injector to be in communication with the port of the multi-way valve connected with the colorimetric detector through the second motor. Then the microprocessor controls the operation of the injection pump through the first motor to pump the first mixture in the injector into the colorimetric detector.

In the step a14, the colorimetric detector detects the first mixture pumped and sends a first detection signal detected to the microprocessor.

Wherein the procedure for obtaining a certain detection signal when each standard solution is mixed with a certain reagent comprises step a21, step a22, step a23 and step a24.

In the step a21, the microprocessor controls the port of the multi-way valve connected with the injector to be in communication with the port of the multi-way valve connected with the standard solution bin through the second motor. Then the microprocessor controls the operation of the injection pump through the first motor to pump a corresponding amount of standard solution into the injector.

The microprocessor controls the port of the multi-way valve connected with the injector to be in communication with the port of the multi-way valve connected with a certain reagent bin through the second motor. Then the microprocessor controls the operation of the injection pump through the first motor to pump a certain quantity of a corresponding reagent in the certain reagent bin into the injector.

In the step a22, the microprocessor controls the port of the multi-way valve connected with the injector to be in communication with the port of the multi-way valve connected with the mixing ring through the second motor. Then the microprocessor controls the injection pump through the first motor to continuously inject and discharge the reagent and the standard solution in the injector from the mixing ring so as to mix the standard solution and the reagent. Pumping a second mixture of the standard solution and the reagent into the injector after mixing.

In the step a23, the microprocessor controls the port of the multi-way valve connected with the injector to be in communication with the port of the multi-way valve connected with the colorimetric detector through the second motor. Then the microprocessor controls the operation of the injection pump through the first motor, and injects the second mixture in the injector into the colorimetric detector.

In the step a24, the colorimetric detector detects the second mixture pumped and sends a second detection signal detected to the microprocessor. Wherein standard solutions with various concentrations are respectively pumped into the standard solution bin in sequence. And each standard solution and a certain reagent are respectively mixed through the above steps to obtain each second detection signal after each standard solution is mixed with the certain reagent.

In the step A2, when analyzing the nutritive salt content of the sample, mixing the sample with a certain reagent to obtain a third detection signal, specific process of the step A2 comprises step a31, step a32, step a33 and step a34.

In the step a31, the microprocessor controls the port of the multi-way valve connected with the injector to be in communication with the port of the multi-way valve connected with the sample channel through the second motor. Then the microprocessor controls the operation of the injection pump through the first motor to pump a corresponding amount of the sample into the injector.

The microprocessor controls the port of the multi-way valve connected with the injector to be in communication with the port of the multi-way valve connected with a certain reagent bin through the second motor. Then the microprocessor controls the operation of the injection pump through the first motor to pump a certain quantity of a corresponding reagent in the certain reagent bin into the injector.

In the step a32, the microprocessor controls the port of the multi-way valve connected with the injector to be in communication with the port of the multi-way valve connected with the mixing ring through the second motor. Then the microprocessor controls the injection pump through the first motor to continuously inject and discharge the reagent and the sample in the injector from the mixing ring so as to mix the sample and the reagent. Pumping a third mixture of the sample and the reagent into the injector after mixing.

In the step a33, the microprocessor controls the port of the multi-way valve connected with the injector to be in communication with the port of the multi-way valve connected with the colorimetric detector through the second motor. Then the microprocessor controls the operation of the injection pump through the first motor to pump the third mixture in the injector into the colorimetric detector.

In the step a34, the colorimetric detector detects the third mixture pumped and sends a third detection signal detected to the microprocessor.

In the step A3, the microprocessor respectively obtains the first detection signal sent by the colorimetric detector when the pure water is mixed with a certain reagent, the second detection signal sent by the colorimetric detector when each standard solution is mixed with the certain reagent, and the third detection signal sent by the colorimetric detector when the sample is mixed with the certain reagent, comparing the third detection signal with the first detection signal and each second detection signal, and obtaining corresponding nutritive salt content in the sample according to the comparison result.

When a sample is required to be mixed with several reagents to obtain the corresponding nutritive salt content in the sample, the method comprises step B1, step B2 and step B3.

In the step B1, the microprocessor obtains detection signals when pure water is mixed with some certain reagents and detection signals when various standard solutions are respectively mixed with the some certain reagents.

Wherein process of obtaining detection signals when pure water is mixed with the some certain reagents comprises step b11, step b12, step b13 and step b14.

In the step b11, the microprocessor controls the port of the multi-way valve connected with the injector to be in communication with the port of the multi-way valve connected with the pure water bin through the second motor. Then the microprocessor controls the operation of the injection pump through the first motor to pump a corresponding amount of pure water into the injector.

Aiming at each reagent bin for storing each reagent correspondingly needing to be mixed with pure water, the microprocessor controls ports in the multi-way valve connected with reagent bins to be respectively in communication with the port in the multi-way valve connected with the injector through the second motor at each moment. Wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector.

In the step b12, the microprocessor controls the port of the multi-way valve connected with the injector to be in communication with the port of the multi-way valve connected with the mixing ring through the second motor. Then the microprocessor controls the operation of the injection pump through the first motor to continuously inject and discharge pure water and various reagents in the injector from the mixing ring so as to mix pure water and the various reagents. Pumping a fourth mixture of pure water and the various reagents into the injector after mixing.

In the step b13, the microprocessor controls the port of the multi-way valve connected with the injector to be in communication with the port of the multi-way valve connected with the colorimetric detector through the second motor. Then the microprocessor controls the operation of the injection pump through the first motor to pump the fourth mixture in the injector into the colorimetric detector.

In the step b14, the colorimetric detector detects the fourth mixture pumped and sends a fourth detection signal detected to the microprocessor.

Wherein process of obtaining detection signals when each standard solution is respectively mixed with some certain reagents comprises step b21, step b22, step b23 and step b24.

In the step b21, the microprocessor controls the port of the multi-way valve connected with the injector to be in communication with the port of the multi-way valve connected with the standard solution bin through the second motor. Then the microprocessor controls the injection pump through the first motor to pump a corresponding amount of standard solution into the injector.

Aiming at each reagent bin for storing each reagent correspondingly needing to be mixed with standard solution, the microprocessor controls ports in the multi-way valve connected with reagent bins to be respectively in communication with the port in the multi-way valve connected with the injector through the second motor at each moment. Wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector.

In the step b22, the microprocessor controls the port of the multi-way valve connected with the injector to be in communication with the port of the multi-way valve connected with the mixing ring through the second motor. Then the microprocessor controls the operation of the injection through the first motor to continuously inject and discharge standard solution and various reagents in the injector from the mixing ring so as to mix the standard solution and the various reagents. Pumping a fifth mixture of the standard solution and the various reagents into the injector after mixing.

In the step b23, the microprocessor controls the port of the multi-way valve connected with the injector to be in communication with the port of the multi-way valve connected with the colorimetric detector through the second motor. Then the microprocessor controls the operation of the injection pump through the first motor to pump the fifth mixture in the injector into the colorimetric detector.

In the step b24, the colorimetric detector detects the fifth mixture pumped and sends a fifth detection signal detected to the microprocessor. Wherein standard solutions with various concentrations are respectively pumped into the standard solution bin in sequence. And each standard solution is respectively mixed with some certain reagents through the above steps to obtain each fifth detection signal after each standard solution is mixed with the some certain reagents.

In the step B2, when analyzing the nutritive salt content of the sample, mixing the sample and some certain reagents to obtain a sixth detection signal. Wherein the specific process of the step B2 comprises step b31, step b32, step b33, step b34.

In the step b31, the microprocessor controls the port of the multi-way valve connected with the injector to be in communication with the port of the multi-way valve connected with the sample channel through the second motor. Then the microprocessor controls the operation the injection pump through the first motor to pump a corresponding amount of sample into the injector.

Aiming at each reagent bin for storing each reagent correspondingly needing to be mixed with the sample, the microprocessor controls ports in the multi-way valve connected with reagent bins to be respectively in communication with the port in the multi-way valve connected with the injector through the second motor at each moment. Wherein when the port of the multi-way valve connected to one of the reagent bins is in communication with the port of the multi-way valve connected with the injector each time, the microprocessor controls the operation of the injection pump through the first motor to pump a corresponding amount of the reagent in the corresponding reagent bin into the injector.

In the step b32, the microprocessor controls the port of the multi-way valve connected with the injector to be in communication with the port connected with the mixing ring through the second motor. Then the microprocessor controls the injection pump through the first motor to continuously inject and discharge the sample and various reagents in the injector from the mixing ring so as to mix the sample and the various reagents. Pumping a sixth mixture of the sample and the various reagents into the injector after mixing.

In the step b33, the microprocessor controls the port of the multi-way valve connected with the injector to be in communication with the port of the multi-way valve connected with the colorimetric detector through the second motor. Then the microprocessor controls the operation of the injection pump through the first motor to pump the sixth mixture in the injector into the colorimetric detector.

In the step b34, the colorimetric detector detects the sixth mixture pumped, and sends a sixth detection signal detected to the microprocessor. Step B3, the microprocessor respectively obtains fourth detection signals sent by the colorimetric detector when pure water is mixed with the some certain reagents, each fifth detection signal sent by the colorimetric detector when each standard solution is respectively mixed with the some certain reagents, and the sixth detection signals sent by the colorimetric detector when the sample is mixed with the some certain reagents, comparing the sixth detection signals, the fourth detection signals and each fifth detection signal, and obtaining the corresponding nutritive salt content in the sample according to the comparison result.

When the nitrate content in the sample needs to be detected, steps thereof comprises step C1, step C2 and step C3.

In the step C1, the microprocessor obtains detection signals when pure water is mixed with a buffer solution and detection signals when various standard solutions are respectively mixed with a buffer solution.

The process of obtaining the detection signal when the pure water is mixed with the buffer solution comprises step c11, step c12, step c13, step c14 and step c15.

In the step c11, the microprocessor controls the port of the multi-way valve connected with the injector to be in communication with the port of the multi-way valve connected with the pure water bin through the second motor. Then the microprocessor controls the operation of the injection pump through the first motor to pump a corresponding amount of pure water into the injector.

The microprocessor controls the port of the multi-way valve connected with the injector to be in communication with the port of the multi-way valve connected with a reagent bin storing the buffer solution through the second motor. Then the microprocessor controls the operation of the injection pump through the first motor to pump a corresponding amount of the buffer solution in the reagent bin storing the buffer solution into the injector.

In the step c12, the microprocessor controls the port in the multi-way valve connected with the injector to be in communication with the port connected with the mixing ring through the second motor. Then the microprocessor controls the operation of the injection pump through the first motor to continuously inject and discharge pure water and the buffer solution in the injector from the mixing ring and pump out the mixing ring so as to mix pure water and the buffer solution. Pumping a seventh mixture of pure water and the buffer solution into the injector after mixing.

In the step c13, the microprocessor controls the port of the multi-way valve connected with the injector to be in communication with the port of the multi-way valve connected with the cadmium column through the second motor. Then the microprocessor controls the operation of the injection pump through the first motor to pump the seventh mixture in the injector into the cadmium column such that the cadmium column reduces the nitrate into nitrite. After waiting for a certain time, the microprocessor controls the operation of the injection pump through the first motor to pump reduced solution reduced by the cadmium column into the injector. In the step, the waiting time is set through the microprocessor according to the reaction time of the nitrate in cadmium column and the sample.

In the step c14, the microprocessor controls the port of the multi-way valve connected with the injector to be in communication with the port of the multi-way valve connected with the colorimetric detector through the second motor. Then the microprocessor controls the operation of the injection pump through the first motor to pump the reduced solution in the injector into the colorimetric detector.

In the step c15, the colorimetric detector detects the reduced solution pumped and sends a seventh detection signal detected to the microprocessor.

Wherein process of obtaining a detection signal when each standard solution is mixed with a buffer solution comprises step c21, step c22, step c23 and step c24.

In the step c21, the microprocessor controls the port of the multi-way valve connected with the injector to be in communication with the port of the multi-way valve connected with the standard solution bin through the second motor. Then the microprocessor controls the injection pump through the first motor to pump a corresponding amount of standard solution into the injector.

The microprocessor controls the port of the multi-way valve connected with the injector to be in communication with the port of the multi-way valve connected with a reagent bin storing the buffer solution through the second motor. Then the microprocessor controls the operation of the injection pump through the first motor to pump a corresponding amount of the buffer solution in the reagent bin storing the buffer solution into the injector.

In the step c22, the microprocessor controls the port in the multi-way valve connected with the injector to be in communication with the port connected with the mixing ring through the second motor. Then the microprocessor controls the operation of the injection pump through the first motor to continuously inject and discharge standard solution and buffer solution in the injector from the mixing ring so as to mix the standard solution and the buffer solution. Pumping an eighth mixture of the standard solution and the buffer solution into the injector after mixing.

In the step c23, the microprocessor controls the port of the multi-way valve connected with the injector to be in communication with the port of the multi-way valve connected with the cadmium column through the second motor. Then the microprocessor controls the operation of the injection pump through the first motor to inject the eighth mixture in the injector into the cadmium column, and the cadmium column reduces the nitrate into nitrite. After waiting for a certain time, the microprocessor controls the operation of the injection pump through the first motor to pump reduced solution reduced by the cadmium column into the injector.

In the step c24, the microprocessor controls the port of the multi-way valve connected with the injector to be in communication with the port of the multi-way valve connected with the colorimetric detector through the second motor. Then the microprocessor controls the operation of the injection pump through the first motor to pump the reduced solution by cadmium column in the injector into the colorimetric detector.

In the step c25, the colorimetric detector detects the reduced solution by cadmium column and sends an eighth detection signal detected to the microprocessor. Wherein the standard solutions with various concentrations are respectively injected into the standard solution bin in sequence. And each standard solution and the buffer solution are respectively mixed through the above steps to obtain each eighth detection signal after each standard solution is mixed with the buffer solution.

In the step C2, when nitrate in the sample needs to be detected, mixing the sample and the buffer solution to obtain a ninth detection signal. Wherein comprises step c31, step c32, step c33, step c34 and step c35.

In the step c31, the microprocessor controls the port of the multi-way valve connected with the injector to be in communication with the port of the multi-way valve connected with the sample channel through the second motor. The microprocessor controls the operation of the injection pump through the first motor to pump a corresponding amount of the sample into the injector.

The microprocessor controls the port of the multi-way valve connected with the injector to be in communication with the port of the multi-way valve connected with a reagent bin storing the buffer solution through the second motor. Then the microprocessor controls the operation of the injection pump through the first motor to pump a corresponding amount of the buffer solution in the reagent bin storing the buffer solution into the injector.

In the step c32, the microprocessor controls the port in the multi-way valve connected with the injector to be in communication with the port connected with the mixing ring through the second motor. Then the microprocessor controls the operation of the injection pump through the first motor to continuously inject and discharge the sample and the buffer solution in the injector from the mixing ring so as to mix the sample and the buffer solution. Pumping a ninth mixture of the sample and the buffer solution into the injector after mixing.

In the step c33, the microprocessor controls the port of the multi-way valve connected with the injector to be in communication with the port of the multi-way valve connected with the cadmium column through the second motor. Then the microprocessor controls the operation of the injection pump through the first motor to inject the ninth mixture in the injector into the cadmium column, and the cadmium column reduces the nitrate into nitrite. After waiting for a certain time, the microprocessor controls the operation of the injection pump through the first motor to pump reduced solution reduced by the cadmium column into the injector.

In the step c34, the microprocessor controls the port of the multi-way valve connected with the injector to be in communication with the port of the multi-way valve connected with the colorimetric detector through the second motor. Then the microprocessor controls the operation of the injection pump through the first motor to pump the reduced solution reduced by the cadmium column in the injector into the colorimetric detector.

In the step c35, the colorimetric detector detects the reduced solution pumped and sends a ninth detection signal detected to the microprocessor.

In the step C3, the microprocessor respectively obtains the seventh detection signals sent by the colorimetric detector when the pure water is mixed with the buffer solution, the eighth detection signal sent by the colorimetric detector when each standard solution is mixed with the buffer solution and the ninth detection signal sent by the colorimetric detector when the sample is mixed with the buffer solution, comparing the ninth detection signal with the seventh detection signal and each eighth detection signal, and obtaining the corresponding nitrate content in the sample according to the comparison result.

When the waste liquid in the colorimetric detector needs to be recovered, the specific steps comprises step D1, step D2, step D3 and step D4.

In the step D1, the microprocessor controls the port of the multi-way valve connected with the injector to be in communication with the port of the multi-way valve connected with the colorimetric detector through the second motor. Then the microprocessor controls the operation of the injection pump through the first motor to pump the solution in the colorimetric detector into the injector.

In the step D2, the microprocessor controls the port of the multi-way valve connected with the injector to be in communication with the port of the multi-way valve connected with the waste liquid collecting device through the second motor. Then the microprocessor controls the operation of the injection pump through the first motor to inject the solution in the injector into the waste liquid collecting device.

In the step D3, the microprocessor controls the port of the multi-way valve connected with the injector to be in communication with the port of the multi-way valve connected with the pure water bin through the second motor. Then the microprocessor controls the operation of the injection pump through the first motor to pump the pure water in the pure water bin into the injector.

In the step D4, the microprocessor controls the port of the multi-way valve connected with the injector to be in communication with the port of the mixing ring through the second motor. Then the microprocessor controls the injection pump through the first motor to continuously inject and discharge pure water in the injector from the mixing ring to clean the mixing ring and the injector through pure water, and finally pumps cleaned solution into the injector. Then, the microprocessor controls the port of the multi-way valve connected with the injector to be in communication with the port of the multi-way valve connected with the waste liquid collecting device through the second motor. Then the microprocessor controls the operation of the injection pump through the first motor to pump the solution in the injector into the waste liquid collecting device.

Wherein in the above steps of the embodiment, when pure water, standard solution or sample need to be mixed with a certain reagent or some certain reagents, the microprocessor can control the sequence of reagent and any of pure water, standard solution and sample to be pumped into the injector arbitrarily. That is, the microprocessor can control pure water, standard solution or sample is pumped into the injector firstly. Then the reagent is pumped into the injector. In turn, the above steps can also be implemented. When there are various reagents, the sequence of each reagent and pure water, standard solution or sample is pumped into the injector can also be arbitrary.

The foregoing embodiments are preferred embodiments of the present invention, but are not intended to be limited by the foregoing embodiments. And any other changes, modifications, substitutions, combinations and simplifications that may be made without departing from the spirit and principles of the present invention shall also fall within the scope of the present invention as equivalent substitutions.

1. An in-situ analyzer for a nutritive salt comprising a microprocessor, a drive component, a multi-way valve with a plurality of ports, an injector, a colorimetric detector, a mixing ring, a sample pipeline, a pure water bin, a standard solution bin, and various reagent bins, wherein the injector, the colorimetric detector, the mixing ring, the sample pipeline, the pure water bin, the standard solution bin and the various reagent bins are respectively connected to corresponding ports of the multi-way valve;
the driving component comprises a first motor driver, a first motor, a second motor driver and a second motor; the microprocessor is connected to the first motor driver and the first motor in turn, and then connected to an injection pump of the injector for controlling the operation of the injection pump; the microprocessor is connected to the second motor driver and the second motor in turn, and then connected to the multi-way valve for controlling one port in the multi-way valve connected to the injector to be in respective and corresponding communication with other ports in the multi-way valve; and
the colorimetric detector is connected with the microprocessor and configured to send a detection signal to the microprocessor such that the microprocessor judges the nutritive nutrient salt content of the sample according to the detection signal.

2. The in-situ analyzer for a nutritive salt of claim 1, wherein the in-situ analyzer further comprises a waste liquid collecting device and a cadmium column, and the waste liquid collecting device and the cadmium column are respectively connected to corresponding ports of the multi-way valve.

3. The in-situ analyzer for a nutritive salt of claim 1, wherein the colorimetric detector includes a light source, a colorimetric cell, a coupling lens and a photoelectric converter; the light source and the coupling lens are respectively arranged at opposite ends of the colorimetric cell; the photoelectric converter is connected to the microprocessor and disposed at a light emitting end of the coupling lens; and in the colorimetric detector, the colorimetric cell is connected and communicated with one port of the multi-way valve.

4. The in-situ analyzer for a nutritive salt of claim 3, wherein the light source is a composite LED light source; or the colorimetric cell is a quartz flow cell with the optical path of 1 cm.

5. The in-situ analyzer for a nutritive salt of claim 4, wherein the sample channel is a Teflon tube; or the multi-way valve is a valve with 8-24 ways.

6. The in-situ analyzer for a nutritive salt of claim 5, wherein the sample channel is a tube with PTFE; or the multi-way valve is a valve with 16 ways.

7. The in-situ analyzer for a nutritive salt of claim 1, wherein the microprocessor communicates with a intelligent terminal through a wireless communication module or a signal line.

8. The in-situ analyzer for a nutritive salt of claim 1, wherein the in-situ analyzer further includes a water-proof protective shell and an upper protective cover, the upper protective cover sealing cover the water-proof protective shell;
the water-proof protective shell is divided into upper and lower cabins which are a waterway protective cabin and a circuit protective cabin respectively by a middle separating layer; wherein the microprocessor, the first motor driver and the second motor driver are all placed in the circuit protective cabin; the multi-way valve, the injector, the injection pump, the first motor, the second motor, the colorimetric detector and the mixing ring are all placed in the waterway protective cabin;
a protective bin is placed above the upper protective cover; the pure water bin, the standard solution bin and various reagent bins are all arranged in the protective bin; a pure water pipeline connected with the pure water bin, a standard solution pipeline connected with the standard solution bin and various reagent pipelines connected with the various reagent bins pass through the protective bin and the upper protective cover, and then respectively and correspondingly connected with various ports of the multi-way valve; and
one end of the sample pipeline is connected with one port of the multi-way valve; the other end thereof passes through the upper protective cover and is arranged outside the water-proof protective shell.

9. The in-situ analyzer for a nutritive salt of claim 8, wherein the water-proof protective shell is mounted in a marine buoy monitoring system; the microprocessor in the circuit protective cabin communicates with a buoy data collector in the marine buoy monitoring system through a signal line or a wireless communication module; the buoy data collector controls the microprocessor to start analysis processing every certain time; meanwhile, the buoy data collector collects a data signal of nutritive salt content of the sample judged by the microprocessor, and transmits the data signal of nutritive salt content to a data center of the marine buoy monitoring system through a wireless communication network.

10. The in-situ analyzer for a nutritive salt of claim 8, wherein the in-situ analyzer further comprises a waste liquid collecting device connected to one port of the multi-way valve; and the waste liquid collecting device is arranged outside the water-proof protective shell.

11. The in-situ analyzer for a nutritive salt of claim 8, wherein the in-situ analyzer further comprises a waste liquid collecting device connected to one port of the multi-way valve; and the waste liquid collecting device is arranged above the upper protective cover.

12. The in-situ analyzer for a nutritive salt of claim 8, wherein the in-situ analyzer further comprises a waste liquid collecting device connected to one port of the multi-way valve; a waste water pipeline connected with the waste liquid collecting device passes through the upper protective cover and is connected with one port of the multi-way valve.

13. A nutritive salt content analysis method, when a sample is required to be mixed with a certain reagent to obtain the corresponding nutritive salt content of the sample, the method comprising:
step A1, the microprocessor obtaining detection signals when pure water and various standard solutions are respectively mixed with a certain reagent;
step A2, when analyzing the nutritive salt content of the sample, mixing the sample with a certain reagent to obtain a third detection signal;
step A3, the microprocessor respectively obtaining the first detection signal sent by the colorimetric detector when the pure water is mixed with a certain reagent, the second detection signal sent by the colorimetric detector when each standard solution is mixed with the certain reagent, and the third detection signal sent by the colorimetric detector when the sample is mixed with the certain reagent, comparing the third detection signal with the first detection signal and each second detection signal, and obtaining corresponding nutritive salt content in the sample according to the comparison result.

14. The nutritive salt content analysis method of 13, wherein the process of obtaining a detection signal when pure water is mixed with a certain reagent comprises:
step a11, pure water injected into the pure water bin, the microprocessor controlling the port of the multi-way valve connected with the injector to be in communication with the port of the multi-way valve connected with the pure water bin through the second motor, then the microprocessor controlling the operation of the injection pump through the first motor to pump a corresponding amount of pure water into the injector;
the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;
step a12, the microprocessor controlling the port of the multi-way valve connected with the injector to be in communication with the port of the multi-way valve connected with the mixing ring through the second motor; then the microprocessor controlling the operation of the injection pump through the first motor to continuously inject and discharge the reagent and pure water in the injector from the mixing ring so as to mix pure water and the reagent; pumping a first mixture of the reagent and pure water into the injector after mixing;
step a13, the microprocessor controlling the port of the multi-way valve connected with the injector to be in communication with the port of the multi-way valve connected with the colorimetric detector through the second motor; and then the microprocessor controlling the operation of the injection pump through the first motor to pump the first mixture in the injector into the colorimetric detector;
step a14, the colorimetric detector detecting the first mixture pumped and sending a first detection signal detected to the microprocessor; or,
wherein the procedure for obtaining a certain detection signal when each standard solution is mixed with a certain reagent comprises:
step a21, the microprocessor controlling the port of the multi-way valve connected with the injector to be in communication with the port of the multi-way valve connected with the standard solution bin through the second motor; then the microprocessor controlling the operation of the injection pump through the first motor to pump a corresponding amount of standard solution into the injector;
the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;
step a22, the microprocessor controlling the port of the multi-way valve connected with the injector to be in communication with the port of the multi-way valve connected with the mixing ring through the second motor; then the microprocessor controlling the injection pump through the first motor to continuously inject and discharge the reagent and the standard solution in the injector from the mixing ring so as to mix the standard solution and the reagent; pumping a second mixture of the standard solution and the reagent into the injector after mixing;
step a23, the microprocessor controlling the port of the multi-way valve connected with the injector to be in communication with the port of the multi-way valve connected with the colorimetric detector through the second motor; then the microprocessor controlling the operation of the injection pump through the first motor, and injecting the second mixture in the injector into the colorimetric detector;
step a24, the colorimetric detector detecting the second mixture pumped and sending a second detection signal detected to the microprocessor; wherein standard solutions with various concentrations are respectively pumped into the standard solution bin in sequence; and each standard solution and a certain reagent are respectively mixed through the above steps to obtain each second detection signal after each standard solution is mixed with the certain reagent.

15. The nutritive salt content analysis method of 13, wherein specific process of the step A2 comprises:
step a31, the microprocessor controlling the port of the multi-way valve connected with the injector to be in communication with the port of the multi-way valve connected with the sample channel through the second motor; then the microprocessor controlling the operation of the injection pump through the first motor to pump a corresponding amount of the sample into the injector;
the microprocessor controlling the port of the multi-way valve connected with the injector to be in communication with the port of the multi-way valve connected with a certain reagent bin through the second motor; then the microprocessor controlling the operation of the injection pump through the first motor to pump a certain quantity of a corresponding reagent in the certain reagent bin into the injector;
step a32, the microprocessor controlling the port of the multi-way valve connected with the injector to be in communication with the port of the multi-way valve connected with the mixing ring through the second motor; then the microprocessor controlling the injection pump through the first motor to continuously inject and discharge the reagent and the sample in the injector from the mixing ring so as to mix the sample and the reagent; pumping a third mixture of the sample and the reagent into the injector after mixing;
step a33, the microprocessor controlling the port of the multi-way valve connected with the injector to be in communication with the port of the multi-way valve connected with the colorimetric detector through the second motor; then the microprocessor controlling the operation of the injection pump through the first motor to pump the third mixture in the injector into the colorimetric detector;
step a34, the colorimetric detector detecting the third mixture pumped and sending a third detection signal detected to the microprocessor; or
when a sample is required to be mixed with several reagents to obtain the corresponding nutritive salt content in the sample, the method comprises:
step B1, the microprocessor obtaining detection signals when pure water is mixed with some certain reagents and detection signals when various standard solutions are respectively mixed with the some certain reagents;
step B2, when analyzing the nutritive salt content of the sample, mixing the sample and some certain reagents to obtain a sixth detection signal;
step B3, the microprocessor respectively obtaining fourth detection signals sent by the colorimetric detector when pure water is mixed with the some certain reagents, each fifth detection signal sent by the colorimetric detector when each standard solution is respectively mixed with the some certain reagents, and the sixth detection signals sent by the colorimetric detector when the sample is mixed with the some certain reagents, comparing the sixth detection signals, the fourth detection signals and each fifth detection signal, and obtaining the corresponding nutritive salt content in the sample according to the comparison result.

16. The nutritive salt content analysis method of 15, wherein process of obtaining detection signals when pure water is mixed with the some certain reagents comprises:
step b11, the microprocessor controlling the port of the multi-way valve connected with the injector to be in communication with the port of the multi-way valve connected with the pure water bin through the second motor; then the microprocessor controlling the operation of the injection pump through the first motor to pump a corresponding amount of pure water into the injector;
aiming at each reagent bin for storing each reagent correspondingly needing to be mixed with pure water, the microprocessor controlling ports in the multi-way valve connected with reagent bins to be respectively in communication with the port in the multi-way valve connected with the injector through the second motor at each moment; wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector;
step b12, the microprocessor controlling the port of the multi-way valve connected with the injector to be in communication with the port of the multi-way valve connected with the mixing ring through the second motor; then the microprocessor controlling the operation of the injection pump through the first motor to continuously inject and discharge pure water and various reagents in the injector from the mixing ring so as to mix pure water and the various reagents; pumping a fourth mixture of pure water and the various reagents into the injector after mixing;
step b13, the microprocessor controlling the port of the multi-way valve connected with the injector to be in communication with the port of the multi-way valve connected with the colorimetric detector through the second motor; then the microprocessor controlling the operation of the injection pump through the first motor to pump the fourth mixture in the injector into the colorimetric detector;
step b14, the colorimetric detector detecting the fourth mixture pumped and sending a fourth detection signal detected to the microprocessor; or,
process of obtaining detection signals when each standard solution is respectively mixed with some certain reagents comprises:
step b21, the microprocessor controlling the port of the multi-way valve connected with the injector to be in communication with the port of the multi-way valve connected with the standard solution bin through the second motor; then the microprocessor controlling the injection pump through the first motor to pump a corresponding amount of standard solution into the injector;
aiming at each reagent bin for storing each reagent correspondingly needing to be mixed with standard solution, the microprocessor controlling ports in the multi-way valve connected with reagent bins to be respectively in communication with the port in the multi-way valve connected with the injector through the second motor at each moment; wherein when the port of the multi-way valve connected with one of the reagent bins is in communication with the port of the multi-way valve connected with the injector each time, the microprocessor controls the operation of the injection through the first motor to pump a corresponding amount of the reagent in the corresponding reagent bin into the injector;
step b22, the microprocessor controlling the port of the multi-way valve connected with the injector to be in communication with the port of the multi-way valve connected with the mixing ring through the second motor; then the microprocessor controlling the operation of the injection through the first motor to continuously inject and discharge standard solution and various reagents in the injector from the mixing ring so as to mix the standard solution and the various reagents; pumping a fifth mixture of the standard solution and the various reagents into the injector after mixing;
step b23, the microprocessor controlling the port of the multi-way valve connected with the injector to be in communication with the port of the multi-way valve connected with the colorimetric detector through the second motor; then the microprocessor controlling the operation of the injection pump through the first motor to pump the fifth mixture in the injector into the colorimetric detector;
step b24, the colorimetric detector detecting the fifth mixture pumped and sends a fifth detection signal detected to the microprocessor; wherein standard solutions with various concentrations are respectively pumped into the standard solution bin in sequence; and each standard solution is respectively mixed with some certain reagents through the above steps to obtain each fifth detection signal after each standard solution is mixed with the some certain reagents; or,
specific process of the step B2 comprises:
step b31, the microprocessor controlling the port of the multi-way valve connected with the injector to be in communication with the port of the multi-way valve connected with the sample channel through the second motor; then the microprocessor controlling the operation the injection pump through the first motor to pump a corresponding amount of sample into the injector;
aiming at each reagent bin for storing each reagent correspondingly needing to be mixed with the sample, the microprocessor controlling ports in the multi-way valve connected with reagent bins to be respectively in communication with the port in the multi-way valve connected with the injector through the second motor at each moment; wherein when the port of the multi-way valve connected to one of the reagent bins is in communication with the port of the multi-way valve connected with the injector each time, the microprocessor controls the operation of the injection pump through the first motor to pump a corresponding amount of the reagent in the corresponding reagent bin into the injector;
step b32, the microprocessor controlling the port of the multi-way valve connected with the injector to be in communication with the port connected with the mixing ring through the second motor; then the microprocessor controlling the injection pump through the first motor to continuously inject and discharge the sample and various reagents in the injector from the mixing ring so as to mix the sample and the various reagents; pumping a sixth mixture of the sample and the various reagents into the injector after mixing;
step b33, the microprocessor controlling the port of the multi-way valve connected with the injector to be in communication with the port of the multi-way valve connected with the colorimetric detector through the second motor; then the microprocessor controlling the operation of the injection pump through the first motor to pump the sixth mixture in the injector into the colorimetric detector;
step b34, the colorimetric detector detecting the sixth mixture pumped, and sending a sixth detection signal detected to the microprocessor.

17. The nutritive salt content analysis method of 13, wherein when the nitrate content in the sample needs to be detected, steps thereof comprise:
step C1, the microprocessor obtaining detection signals when pure water is mixed with a buffer solution and detection signals when various standard solutions are respectively mixed with a buffer solution;
step C2, when nitrate in the sample needs to be detected, mixing the sample and the buffer solution to obtain a ninth detection signal;
step C3, the microprocessor respectively obtaining the seventh detection signals sent by the colorimetric detector when the pure water is mixed with the buffer solution, the eighth detection signal sent by the colorimetric detector when each standard solution is mixed with the buffer solution and the ninth detection signal sent by the colorimetric detector when the sample is mixed with the buffer solution, comparing the ninth detection signal with the seventh detection signal and each eighth detection signal, and obtaining the corresponding nitrate content in the sample according to the comparison result.

18. The nutritive salt content analysis method of 17, wherein the process of obtaining the detection signal when the pure water is mixed with the buffer solution comprising:
step c11, the microprocessor controlling the port of the multi-way valve connected with the injector to be in communication with the port of the multi-way valve connected with the pure water bin through the second motor; then the microprocessor controlling the operation of the injection pump through the first motor to pump a corresponding amount of pure water into the injector;
the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;
step c12, the microprocessor controlling the port in the multi-way valve connected with the injector to be in communication with the port connected with the mixing ring through the second motor; then the microprocessor controlling the operation of the injection pump through the first motor to continuously inject and discharge pure water and the buffer solution in the injector from the mixing ring and pump out the mixing ring so as to mix pure water and the buffer solution; pumping a seventh mixture of pure water and the buffer solution into the injector after mixing;
step c13, the microprocessor controlling the port of the multi-way valve connected with the injector to be in communication with the port of the multi-way valve connected with the cadmium column through the second motor; then the microprocessor controlling the operation of the injection pump through the first motor to pump the seventh mixture in the injector into the cadmium column such that the cadmium column reduces the nitrate into nitrite; after waiting for a certain time, the microprocessor controlling the operation of the injection pump through the first motor to pump reduced solution reduced by the cadmium column into the injector;
step c14, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution in the injector into the colorimetric detector;
step c15, the colorimetric detector detecting the reduced solution pumped and sends a seventh detection signal detected to the microprocessor; or,
process of obtaining a detection signal when each standard solution is mixed with a buffer solution comprises:
step c21, the microprocessor controlling the port of the multi-way valve connected with the injector to be in communication with the port of the multi-way valve connected with the standard solution bin through the second motor; then the microprocessor controlling the injection pump through the first motor to pump a corresponding amount of standard solution into the injector;
the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;
step c22, the microprocessor controlling the port in the multi-way valve connected with the injector to be in communication with the port connected with the mixing ring through the second motor; then the microprocessor controlling the operation of the injection pump through the first motor to continuously inject and discharge standard solution and buffer solution in the injector from the mixing ring so as to mix the standard solution and the buffer solution; pumping an eighth mixture of the standard solution and the buffer solution into the injector after mixing;
step c23, the microprocessor controlling the port of the multi-way valve connected with the injector to be in communication with the port of the multi-way valve connected with the cadmium column through the second motor; then the microprocessor controlling the operation of the injection pump through the first motor to inject the eighth mixture in the injector into the cadmium column, and the cadmium column reducing the nitrate into nitrite; after waiting for a certain time, the microprocessor controlling the operation of the injection pump through the first motor to pump reduced solution reduced by the cadmium column into the injector;
step c24, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution by cadmium column in the injector into the colorimetric detector;
step c25, the colorimetric detector detecting the reduced solution by cadmium column and sends an eighth detection signal detected to the microprocessor; wherein the standard solutions with various concentrations are respectively injected into the standard solution bin in sequence; and each standard solution and the buffer solution are respectively mixed through the above steps to obtain each eighth detection signal after each standard solution is mixed with the buffer solution.

19. The nutritive salt content analysis method of 17, wherein specific steps of the steps C2 comprises:
step c31, the microprocessor controlling the port of the multi-way valve connected with the injector to be in communication with the port of the multi-way valve connected with the sample channel through the second motor; the microprocessor controlling the operation of the injection pump through the first motor to pump a corresponding amount of the sample into the injector;
the microprocessor controlling the port of the multi-way valve connected with the injector to be in communication with the port of the multi-way valve connected with a reagent bin storing the buffer solution through the second motor; then the microprocessor controlling the operation of the injection pump through the first motor to pump a corresponding amount of the buffer solution in the reagent bin storing the buffer solution into the injector;
step c32, the microprocessor controlling the port in the multi-way valve connected with the injector to be in communication with the port connected with the mixing ring through the second motor; then the microprocessor controlling the operation of the injection pump through the first motor to continuously inject and discharge the sample and the buffer solution in the injector from the mixing ring so as to mix the sample and the buffer solution; pumping a ninth mixture of the sample and the buffer solution into the injector after mixing;
step c33, the microprocessor controlling the port of the multi-way valve connected with the injector to be in communication with the port of the multi-way valve connected with the cadmium column through the second motor; then the microprocessor controlling the operation of the injection pump through the first motor to inject the ninth mixture in the injector into the cadmium column, and the cadmium column reducing the nitrate into nitrite; after waiting for a certain time, the microprocessor controlling the operation of the injection pump through the first motor to pump reduced solution reduced by the cadmium column into the injector;
step c34, the microprocessor controlling the port of the multi-way valve connected with the injector to be in communication with the port of the multi-way valve connected with the colorimetric detector through the second motor; then the microprocessor controlling the operation of the injection pump through the first motor to pump the reduced solution reduced by the cadmium column in the injector into the colorimetric detector;
step c35, the colorimetric detector detecting the reduced solution pumped and sending a ninth detection signal detected to the microprocessor.

20. The nutritive salt content analysis method of 13, wherein when the waste liquid in the colorimetric detector needs to be recovered, specific steps comprise:
step D1, the microprocessor controlling the port of the multi-way valve connected with the injector to be in communication with the port of the multi-way valve connected with the colorimetric detector through the second motor; then the microprocessor controlling the operation of the injection pump through the first motor to pump the solution in the colorimetric detector into the injector;
step D2, the microprocessor controlling the port of the multi-way valve connected with the injector to be in communication with the port of the multi-way valve connected with the waste liquid collecting device through the second motor; then the microprocessor controlling the operation of the injection pump through the first motor to inject the solution in the injector into the waste liquid collecting device;
step D3, the microprocessor controlling the port of the multi-way valve connected with the injector to be in communication with the port of the multi-way valve connected with the pure water bin through the second motor; then the microprocessor controlling the operation of the injection pump through the first motor to pump the pure water in the pure water bin into the injector;
step D4, the microprocessor controlling the port of the multi-way valve connected with the injector to be in communication with the port of the mixing ring through the second motor; then the microprocessor controlling the injection pump through the first motor to continuously inject and discharge pure water in the injector from the mixing ring to clean the mixing ring and the injector through pure water, and finally pumps cleaned solution into the injector; then the microprocessor controlling the port of the multi-way valve connected with the injector to be in communication with the port of the multi-way valve connected with the waste liquid collecting device through the second motor; then the microprocessor controlling the operation of the injection pump through the first motor to pump the solution in the injector into the waste liquid collecting device.
